(19) United States
(12) Patent Application Publication
(10) Pub. No.: US 2007/0097587 A1
(43) Pub. Date: May 3, 2007

(54) Inductive load drive device and drive method

(75) Inventor: Hideki Shirokoshi, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/549,343

(22) Filed: Oct. 13, 2006

(30) Foreign Application Priority Data
Oct. 18, 2005 (JP) 2005-302643

(51) Int. Cl. H01H 47/00

(52) U.S. Cl. 361/139

(57) ABSTRACT

An inductive load drive device for driving an inductive load shortens the attenuation time of the regenerative current produced in the inductive load without increasing capacitance between the power supply and ground. A drive signal generating unit produces a drive signal denoting a logic level of the drive state and regeneration state. A drive unit is controlled based on the drive signal to an OFF state, a high resistance ON state having a high ON resistance, or a low resistance ON state having a low ON resistance, to produce the drive power. The drive unit has a high potential side switching unit group and a low potential side switching unit group. In the regeneration state either the high potential side switching unit group or the low potential side switching unit group is OFF and at least one switching unit of the other switching unit group is on.

### BACKGROUND OF THE INVENTION

1. Field of Invention

The present invention relates to technology for shortening the regenerative current attenuation time and reducing capacitance between the power supply and ground in an inductive load drive circuit that can drive an inductive load in a single direction or in both normal and reverse directions.

2. Description of Related Art

Inductive load drive devices are used, for example, to drive the mechanical shutter in digital cameras, and shortening the time required for forward/reverse phase switching of the inductive load is desired. Reducing the forward/reverse phase switching time requires shortening the attenuation time of the regenerative current that is produced in the inductive load when the phase is switched. Japanese Unexamined Patent Appl. Pub. H5-268036 teaches an inductive load drive circuit that addresses this problem as described below with reference to FIG. 19.

The inductive load drive circuit shown in FIG. 19 has a power supply 6p, a capacitance 7p between the power supply and ground, a high potential side transistor 101p, low potential side diode 102p, high potential side diode 103p, low potential side transistor 104p, output drive transistor control circuit 205p, and inductive load 8p. Operation of this inductive load drive circuit is described next.

The output drive transistor control circuit 205p first turns the high potential side transistor 101p and low potential side transistor 104p on. When the high potential side transistor 101p and low potential side transistor 104p then turn off simultaneously, the energy stored in the inductive load 8p is attenuated by flowing as a regenerative current through the low potential side diode 102p, inductive load 8p, and high potential side diode 103p to the power supply 6p.

This attenuation time Tp is defined as:
Tp=Lp/Vp×Ip
where Lp is the inductance of the inductive load 8p, Vp is the voltage applied to both ends of the inductive load 8p, and Ip is the current flowing to the inductive load 8p while the transistors 101p and 104p are on. As this equation shows, increasing the terminal voltage Vp of the inductive load 8p can decrease the attenuation time Tp.

In Japanese Unexamined Patent Appl. Pub. H5-268036,
Vp=(voltage of power supply 6p)+(forward voltage of low potential side diode 102p)+(forward voltage of high potential side diode 103p)
and the terminal voltage Vp of the inductive load 8p can be increased. As a result, an inductive load drive device that can shorten the regenerative current attenuation time can be provided.

As electronic devices continue to become smaller, reducing the size of all components, including external components, has become increasingly important. The inductive load drive device taught in Japanese Unexamined Patent Appl. Pub. H5-268036 shortens the attenuation time by passing the regenerative current to the power supply 6p. The power supply 6p normally has no ability to pull current, and therefore uses an internal resistance 306p to transiently boost the power supply 6p voltage as shown in FIG. 19. The power supply voltage can therefore exceed the withstand voltage of the inductive load drive device and possibly damage the drive device. To avoid such damage, the capacitance of the power supply—ground capacitance 7p must be set high to suppress an increase in the power supply voltage. This necessarily increases the physical size of the supply-ground capacitance 7p and makes incorporating the inductive load drive device in small electronic devices, particularly cell phones, difficult.

### SUMMARY OF THE INVENTION

The present invention therefore shortens the attenuation time of the regenerative current that is produced in the inductive load during phase switching without increasing the capacitance between the power supply and ground.

An inductive load drive device according to a first aspect of the invention is a device operable to drive an inductive load by repeatedly switching between a drive state supplying drive power to the inductive load and a regeneration state in which regenerative power from the inductive load is received, and has a drive signal generator operable to generate a drive signal denoting a logic level of the drive state and the regeneration state, and a driver that is controlled based on the drive signal to an OFF state, a high resistance ON state having a high on resistance, or a low resistance ON state having a low on resistance operable to generate the drive power. The driver has a high potential side switching unit group having at least one switching unit, and a low potential side switching unit group having at least one switching unit. When in the regeneration state, the switching unit group of the high potential side switching unit group or the low potential side switching unit group is controlled to the OFF state and at least one switching unit of the other switching unit group is controlled to the high resistance ON state.

An inductive load drive method according to another aspect of the invention is a method operable to drive an inductive load by repeatedly switching between a drive state supplying drive power to the inductive load and a regeneration state receiving regenerative power from the inductive load by a high potential side switching unit group having at least one switching unit and a low potential side switching unit group having at least one switching unit, and has steps of: generating a drive signal denoting a logic level of the drive state and the regeneration state, generating the drive power controlled to an OFF state, a high resistance ON state having a high ON resistance, or a low resistance ON state having a low ON resistance based on the drive signal, and turning the switching unit group of the high potential side switching unit group or the low potential side switching unit group off and setting at least one switching unit of the other switching unit group to the high resistance ON state when in the regeneration state.

The regenerative current does not flow to the power supply side with the inductive load drive device and drive method of the invention, and the power supply voltage is therefore not increased by inflowing current even when there is an internal resistance in the power supply. The withstand voltage of the inductive load drive device can therefore be designed without an extra safety margin, the size of the capacitance between the power supply and ground can therefore be reduced, and the cost can therefore be reduced. The attenuation time of the regenerative current can therefore be shortened, the regeneration state can be minimized, and the forward/reverse phase switching time of the inductive load can be shortened.

More specifically, controlling the on resistance of the transistor enables increasing the resistance of the regenerative current path and enables shortening the regenerative current attenuation time because the current consumption time of the path resistance is shortened.

Furthermore, because transistor on resistance can be feedback controlled to maximize the drain voltage while not exceeding the withstand voltage of the inductive load drive device, the resistance of the regenerative current path can be maximized more appropriately and the regenerative current attenuation time can be shortened even more because this path resistance shortens the power consumption time.

In addition, the resistance of the regenerative current path can be increased by selectively using a high ON resistance transistor in the regeneration state, and the regenerative current attenuation time can be shortened even more because this path resistance shortens the power consumption time.

Yet further, by selecting the number of transistors that are on in the regenerative current path, the path resistance can be increased and the regenerative current attenuation time can be further shortened because this path resistance shortens the power consumption time.

The regenerative current attenuation time can be yet further shortened by monitoring regenerative current attenuation and switching to the reverse phase drive state as soon as attenuation is completed.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic block diagram of an inductive load drive device according to a first embodiment of the invention.

FIG. 2 describes the current path in an inductive load drive device according to a first embodiment of the invention.

FIG. 3 is a timing chart describing the operation of the drive unit in an inductive load drive device according to a first embodiment of the invention.

FIG. 4 is a schematic block diagram of an inductive load drive device according to a second embodiment of the invention.

FIG. 5 is a timing chart describing the operation of the drive unit in an inductive load drive device according to a second embodiment of the invention.

FIG. 6 is a schematic block diagram of an inductive load drive device according to a third embodiment of the invention.

FIG. 7 is a partial circuit diagram describing the operation of an inductive load drive device according to a third embodiment of the invention.

FIG. 8 is a timing chart describing the operation of the drive unit in an inductive load drive device according to a third embodiment of the invention.

FIG. 9 is a schematic block diagram of an inductive load drive device according to a fourth embodiment of the invention.

FIG. 10 is a schematic block diagram of an inductive load drive device according to a fifth embodiment of the invention.

FIG. 11 is a schematic block diagram of an inductive load drive device according to a sixth embodiment of the invention.

FIG. 12 is a timing chart describing the operation of the drive unit in an inductive load drive device according to a sixth embodiment of the invention.

FIG. 13 is a schematic block diagram of an inductive load drive device according to a seventh embodiment of the invention.

FIG. 14 is a schematic block diagram of an inductive load drive device according to an eighth embodiment of the invention.

FIG. 15 is a schematic block diagram of an inductive load drive device according to a ninth embodiment of the invention.

FIG. 16 is a schematic block diagram of an inductive load drive device according to a tenth embodiment of the invention.

FIG. 17 is a partial circuit diagram describing the operation of an inductive load drive device according to a tenth embodiment of the invention.

FIG. 18 is a timing chart describing the operation of the drive unit in an inductive load drive device according to a tenth embodiment of the invention.

FIG. 19 is a schematic block diagram showing the arrangement of an inductive load drive device according to the related art.

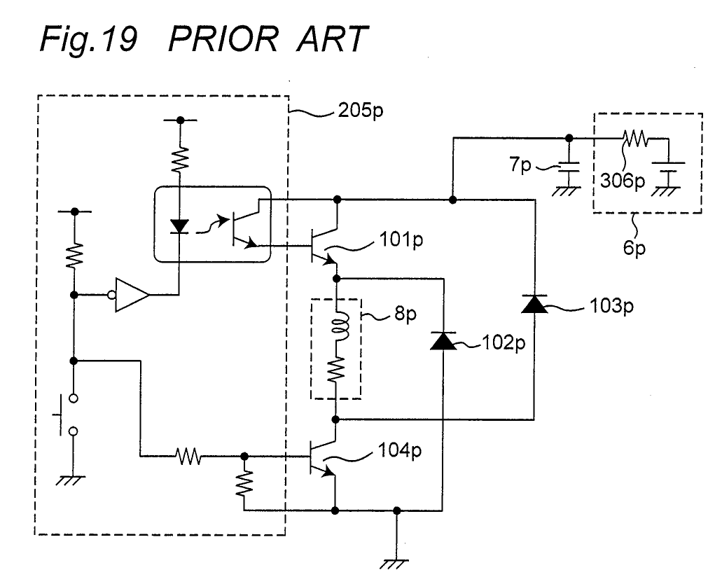

### DETAILED DESCRIPTION OF THE PREFERRED EMBODIMENTS

Preferred embodiments of the present invention are described below with reference to the accompanying figures. Numeric values used in the following description of the invention are used by way of example to better describe the invention, and the invention is not limited to these values.

### First Embodiment

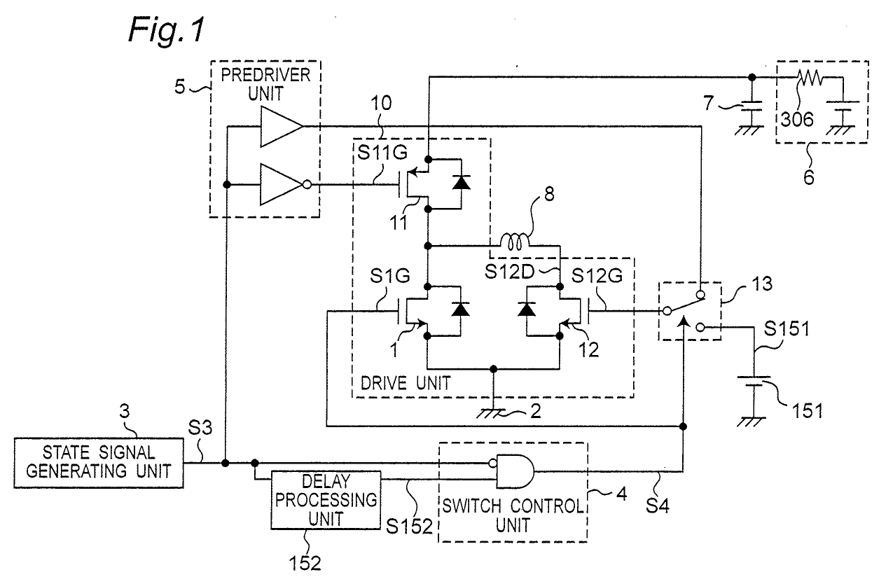

FIG. 1 is a schematic block diagram of an inductive load drive device according to a first embodiment of the invention.

An inductive load drive device according to the present invention supplies drive power to an inductive load 8.

The period when drive power is supplied is called the “drive period” below, and the operating state at that time is called the “drive state.”

The period when supplying drive power stops and regenerative power from the inductive load 8 is received is called the “regeneration period,” and the operating state at that time is called the “regeneration state.”

An inductive load drive device according to the invention is a device for driving an inductive load 8 by repeatedly switching between the drive state supplying drive power to the inductive load 8, and the regeneration state receiving drive power from the inductive load 8.

The inductive load drive device shown in FIG. 1 has a drive unit 10 for supplying drive power to the inductive load 8, a predriver unit 5, a power supply 6, a ground 2, a capacitance between the power supply and ground 7, an internal resistance 306 in the power supply, and a state signal generating unit 3 that outputs a state signal S3 indicating whether the current operating state is the drive state or regeneration state. A delay processing unit 152 generates a delay processing signal S152 that goes high for a predetermined regeneration period starting from when the state signal S3 switches from the drive state to the regeneration state.

The drive unit 10 includes a high potential side switching unit 11 and low potential side switching units 12 and 1. The low potential side switching unit 1 has a regeneration switching function. The high potential side switching unit 11 renders a high potential side switching unit group, and the low potential side switching units 12 and 1 together render a low potential side switching unit group. Each switching unit 11, 12, 1 has a body diode parallel connected in reverse conductivity. Switch 13 switches the gate voltage S12G of the low potential side switching unit 12, and switch control unit 4 generates the switch control signal S4 that controls switch 13 and the gate voltage S1G of the low potential side switching unit 12. The switch control unit 4 generates the switch control signal S4 by taking the logical product of the delay processing signal S152 and the inverse of the state signal S3. The switch 13 selects the output of the predriver unit 5 when the switch control signal S4 is LOW, and selects the regenerative gate voltage source 151 when the switch control signal S4 is HIGH.

The state signal generating unit 3, delay processing unit 152, predriver unit 5, switch control unit 4, switch 13, and regenerative gate voltage source 151 render a drive signal generating unit. The gate voltages S11G, S1G, and S12G applied by the drive signal generating unit are collectively called the drive signal. The drive signal represents the logic level of the drive state and regeneration state.

The switching units 11, 12, and 1 in this embodiment of the invention are MOS transistors, bipolar transistors, IGBT (insulated gate bipolar transistors), or other type of circuit that can be switched by a applying a control signal. An n-channel MOS transistor is used for the low potential side switching unit, and a p-channel MOS transistor is used for the high potential side switching unit in this embodiment of the invention. In this case the control node of the switching unit is the gate, the first main node is the drain, and the second main node is the source. The voltage applied to the control node is the gate voltage, the voltage at the first main node is the drain voltage, and the voltage at the second main node is the source voltage.

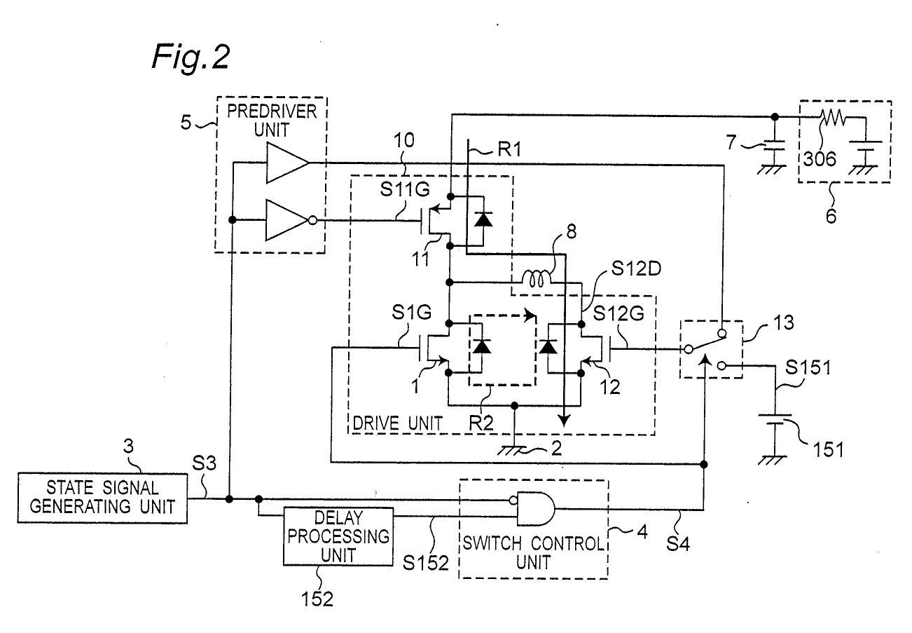

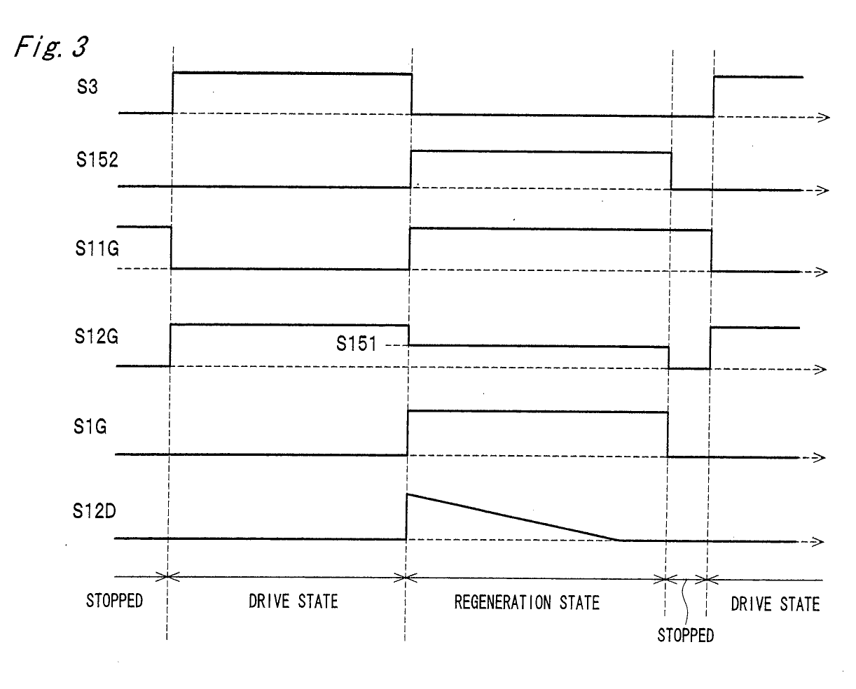

The operation of this inductive load drive device is described next with reference to FIG. 1 and FIG. 2. FIG. 3 is a timing chart of the signals in this inductive load drive device.

In the drive state the state signal S3 is HIGH, the delay processing signal S152 is LOW, the gate voltage S11G of the high potential side switching unit 11 goes LOW, and the high potential side switching unit 11 is therefore ON. The switch control signal S4 goes LOW during the drive state, the gate voltage S1G of the low potential side switching unit 1 goes LOW, and the low potential side switching unit 1 is therefore OFF. The switch 13 switches to the predriver unit 5 side, and the low potential side switching unit 12 goes ON. As indicated by solid line arrow R1 in FIG. 2, the drive current therefore flows through the drive current path from the power supply 6 through the high potential side switching unit 11, inductive load 8, low potential side switching unit 12, and to ground 2. This path of drive current flow is called the “drive current path” below.

To stop driving and change to the regeneration state from the drive state, the state signal S3 goes from HIGH to LOW and the high potential side switching unit 11 turns OFF. The characteristics of the inductive load 8 cause regenerative current to continue flowing to the inductive load 8 until the energy stored during the drive period is completely discharged. Because the delay processing signal S152 goes HIGH for the predetermined regeneration period starting from when the state signal S3 switches to the regeneration state, the switch control signal S4 goes HIGH, the low potential side switching unit 1 is ON, and the switch 13 is connected to the regenerative gate voltage source 151.

The change in the regenerative current I(t) flowing to the inductive load 8 at time t in the regeneration state is represented by equation (1)
dl(t)/dt=−Vd/L
Vd=Ron×I(t) (1)
and the regenerative current I(t) is therefore represented by equation (2)
I(t)=(Imax)×(exp(−Ron/L×t)) (2)
where Imax is the maximum current flow through the inductive load 8 during the drive period, L is the inductance of the inductive load 8, Ron is the on resistance of the low potential side switching unit 12, and Vd is the drain-source voltage of the low potential side switching unit 12. The time required for I(t) to become sufficiently small, such as 1/100, can be derived from equation (2), and the regeneration period of the delay processing unit 152 can be set based on this time.

In the regeneration state the gate voltage S12G of the low potential side switching unit 12 is regenerative gate voltage S151, which is a lower voltage than the state signal S3, and the on resistance Ron of the low potential side switching unit 12 therefore rises. The ON state in which the on resistance of the switching unit is high is called the “high resistance ON state,” and the ON state in which the on resistance of the switching unit is low is called the “low resistance ON state.” The state when the gate voltage of the switching unit is sufficiently high is called the “full ON state,” and the state in which the switching unit gate voltage is, like the regenerative gate voltage S151, lower than in the full ON state is the “half ON state.” The full ON state and half ON state are collectively referred to simply the ON state.

As indicated by imaginary line arrow R2 in FIG. 2, the regenerative current flows through the regenerative current path from ground 2 to the low potential side switching unit 1 in the low resistance ON state of the full ON mode, the inductive load 8, the low potential side switching unit 12 in the high resistance ON state of the half ON mode, and back to ground 2. This path through which the regenerative current flows is called the regenerative current path. Because no part of the regenerative current path flows to the power supply 6, the supply-to-ground capacitance 7 can be low. In addition, because the ON resistance of the low potential side switching unit 12 is high, the voltage at both ends of the inductive load 8 can be set high and the time required for regenerative current attenuation can be shortened. When the predetermined regeneration period of the delay processing unit 152 ends, the switch control signal S4 goes LOW and the low potential side switching unit 1 therefore turns off. The switch 13 also selects output from the predriver unit 5 and outputs low, and the low potential side switching unit 12 therefore turns off. That is, the drive unit 10 stops. When the state signal S3 then goes HIGH again, the drive state is resumed.

The method of setting the regenerative gate voltage S151 is described below. If Vs is the voltage of the power supply 6, Vf is the normal forward voltage of the body diode of the high potential side switching unit 11, Imax is the maximum current flow through the inductive load 8 in the drive period, and Ron is the on resistance of the low potential side switching unit 12, then Ron is set so that equation (3) is true.
Imax)×(Ron)<Vs+Vf (3)
The regenerative gate voltage S151 is then set based on the relationship between the ON resistance Ron and gate voltage S12G of the low potential side switching unit 12. The greatest ON resistance Ron that satisfies equation (3) is selected in order to minimize the attenuation time. The relationship between the ON resistance Ron and gate voltage S12G greatly depends on the size and process of the switching unit that is used, and description thereof is thus omitted here.

Equation (3) also assumes that
Vmax>Vs+Vf
is true where Vmax is the withstand voltage of the used components. If
Vmax<Vs+Vf
then equation (3) is
(Imax)×(Ron)<Vmax. (4)
Substituting actual values into the above equations, if parts with a 5-V withstand voltage are used, the drive current during the drive state is 200 mA. If the regenerative gate voltage source 151 sets the ON resistance Ron of the low potential side switching unit 12 to 25 Ω, the regenerative current can be quickly attenuated without exceeding the withstand voltage. FIG. 3 describes the change over time in the gate voltage of each switching unit in the drive unit 10. The drain voltage S12D of the low potential side switching unit 12 decreases as the regenerative current attenuates.

An inductive load drive device according to this aspect of the invention thus turns the high potential side switching unit 11 off during the regeneration state to prevent regenerative current flow to the power supply 6. As a result, the power supply voltage will not rise due to current inflow even if an internal resistance 306 is present in the power supply. An extra safety margin is therefore not required when setting the withstand voltage of the inductive load drive device and the size of the supply-to-ground capacitance 7 can therefore be reduced, thus affording a low unit cost. The regeneration period can also be shortened because the regenerative current attenuation time can be shortened.

More specifically, the resistance of the regenerative current path can be increased by controlling the ON resistance of the low potential side switching unit, the power consumption time is shortened by the path resistance, and the regenerative current attenuation time can be shortened.

The high potential side switching unit 11 is a p-channel MOS transistor in this embodiment of the invention, but the same effect can be achieved using an n-channel MOS transistor instead. The switch control unit 4 and predriver unit 5 are preferably logic circuits as shown in FIG. 1, but other devices that operate as described above can be used instead.

### Second Embodiment

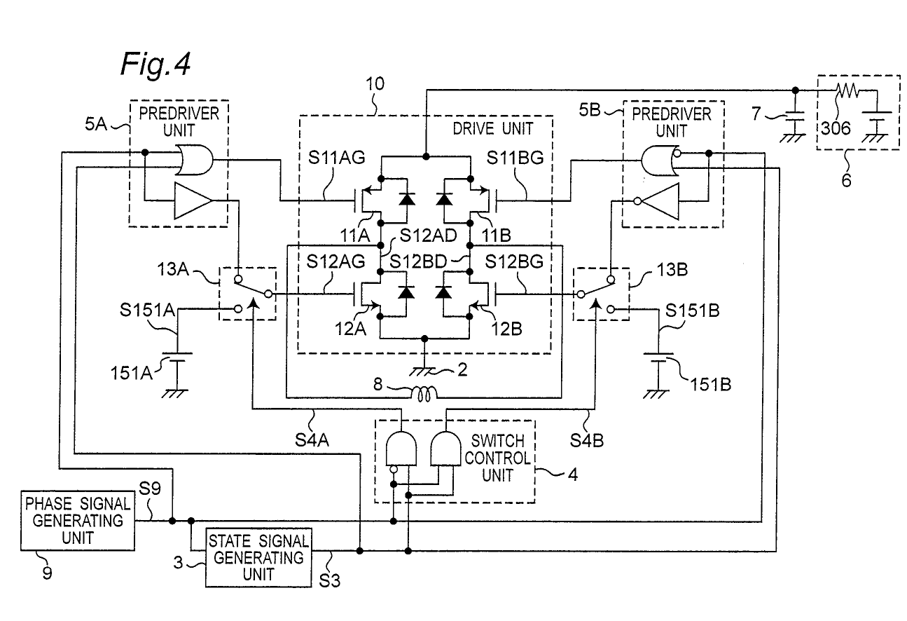

FIG. 4 is a schematic block diagram of an inductive load drive device according to a second embodiment of the invention. The first embodiment described above can drive the inductive load 8 in only one direction. This second embodiment differs in being able to drive the inductive load 8 in both forward and reverse directions. This embodiment is described below with particular reference to the differences between this embodiment and the first embodiment.

Shown in FIG. 4 are the inductive load 8, a drive unit 10 for supplying drive power to the inductive load 8, predriver units 5A and 5B, a power supply 6, a ground 2, a capacitance between the power supply and ground 7, an internal resistance 306 in the power supply, and a phase signal generating unit 9 for generating a phase signal S9 representing forward or reverse phase state information. A state signal generating unit 3 outputs a state signal S3 indicating whether the current operating state is the drive state or regeneration state. The state signal S3 goes HIGH for a predetermined regeneration period starting when the phase signal S9 changes phase.

The drive unit 10 includes high potential side switching units 11A and 11B, and low potential side switching units 12A and 12B. The high potential side switching units 11A and 11B together render a high potential side switching unit group, and the low potential side switching units 12A and 12B together render a low potential side switching unit group. Each switching unit 11A, 11B, 12A, 12B has a body diode parallel connected in reverse conductivity. Similarly to the first embodiment, the low potential side switching units 12A and 12B have a regeneration switching function.

Switches 13A and 13B switch the gate voltage S12AG, S12BG of the low potential side switching units 12A and 12B. The switch control unit 4 generates the switch control signals S4A and S4B that control the switches 13A and 13B, respectively. When the switch control signal S4A, S4B is LOW, the corresponding switch 13A and 13B selects the output from the predriver units 5A and 5B, and selects the regenerative gate voltage source 151A, 151B when the switch control signal S4A and S4B is HIGH.

The phase signal generating unit 9, state signal generating unit 3, predriver units 5A and 5B, switch control unit 4, switches 13A and 13B, and regenerative gate voltage source 151A, 151B together render a drive signal generating unit. The gate voltages S11AG, S11BG, S12AG, and S12BG applied by the drive signal generating unit are collectively called the drive signal. The drive signal represents the logic level of the drive state and regeneration state.

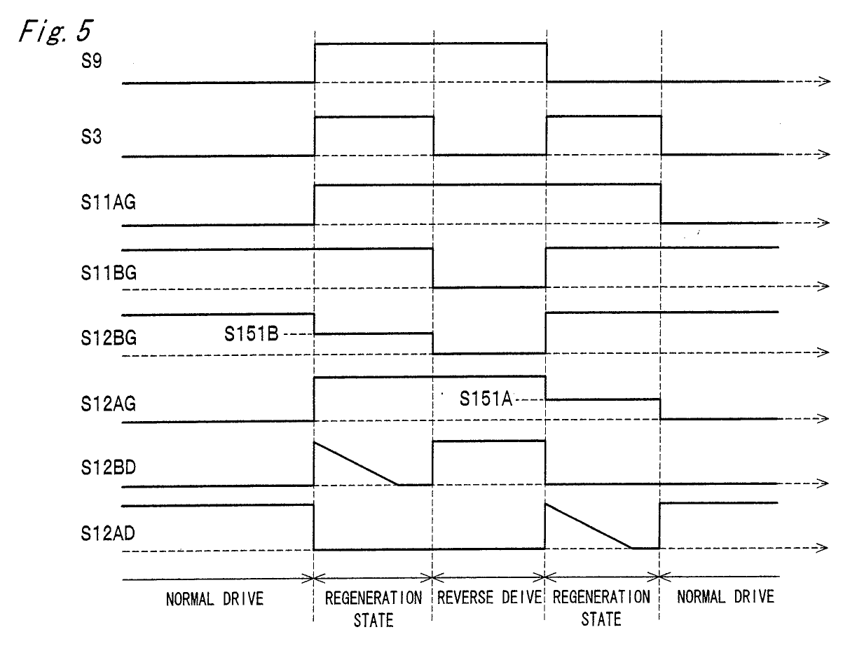

The operation of this inductive load drive device during phase switching is described next with reference to FIG. 4. FIG. 5 is a timing chart of the signals during this operation.

In the normal phase (forward) drive state the phase signal S9 and state signal S3 are LOW, the high potential side switching unit 11A is on, and the high potential side switching unit 11B is off. The switch control signals S4A and S4B are LOW, switches 13A and 13B are set to the predriver unit 5A and 5B side, respectively, low potential side switching unit 12A is OFF, and low potential side switching unit 12B is ON. The drive current therefore flows from the power supply 6 to the high potential side switching unit 11A, inductive load 8, low potential side switching unit 12B, and to ground 2 through the drive current path.

When the phase is changed from this normal (forward) phase drive state, the phase signal S9 goes from LOW to HIGH and high potential side switching unit 11A goes off. The state signal S3 goes HIGH for a predetermined regeneration period starting when the phase signal S9 changes phase. As a result, the high potential side switching unit 11B also goes OFF. The characteristics of the inductive load 8 cause regenerative current to continue flowing to the inductive load 8 until the energy stored during the drive period is completely discharged. Switching control signal S4A goes LOW, switching control signal S4B goes HIGH, switch 13A is set to the predriver unit 5A side, and switch 13B is set to the regenerative gate voltage source 151B side. The low potential side switching unit 12A goes to the full ON low resistance ON state, but because the gate voltage S12BG of the low potential side switching unit 12B goes to regenerative gate voltage S151B, low potential side switching unit 12B goes to the half ON high resistance ON state.

The regenerative current therefore flows through the regenerative current path from ground 2 to the low potential side switching unit 12A in a full ON low resistance ON state, the inductive load 8, the low potential side switching unit 12B in a half ON high resistance ON state, and to ground 2. Because no part of the regenerative current path flows to the power supply 6, the supply-to-ground capacitance 7 can be low. In addition, because the ON resistance of the low potential side switching unit 12B is high, the voltage at both ends of the inductive load 8 can be set high and the time required for regenerative current attenuation can be shortened.

The regeneration period can be set from equation (2) as described in the first embodiment, and the regenerative gate voltage S151B can be determined from equation (3). FIG. 5 shows the change over time in the gate voltage of each switching unit. In the regeneration state the drain voltage S12BD of the low potential side switching unit 12B in the half ON high resistance ON state gradually decreases with regenerative current attenuation.

The inductive load drive device then enters the reverse phase drive state after the regeneration period set by the state signal generating unit 3. The high potential side switching unit 11B and low potential side switching unit 12A are thus on, and the drive current flows through the drive current path from the power supply 6 to the high potential side switching unit 11B, inductive load 8, low potential side switching unit 12A, and to ground 2.

The inductive load drive device according to this second embodiment of the invention thus controls the high potential side switching unit group to the off state during the regeneration period so that regenerative current does not flow to the power supply 6. As a result, the power supply voltage will not rise due current inflow even if an internal resistance 306 is present in the power supply. An extra safety margin is therefore not required when setting the withstand voltage of the inductive load drive device and the size of the supply-to-ground capacitance 7 can therefore be reduced, thus affording a low unit cost. The regeneration period can also be shortened because the regenerative current attenuation time can be shortened, and the time required to switch the phase of the inductive load between forward and reverse can be shortened.

More specifically, the resistance of the regenerative current path can be increased by controlling the ON resistance of the low potential side switching unit, the power consumption time is shortened by the path resistance, and the regenerative current attenuation time can be shortened.

Phase switching from the forward phase drive state (with current flowing through the drive current path from the power supply 6 to the high potential side switching unit 11A, inductive load 8, low potential side switching unit 12B, and to ground 2) to the reverse phase drive state (with current flowing through the drive current path from the power supply 6 to the high potential side switching unit 11B, inductive load 8, low potential side switching unit 12A, and to ground 2) is described above. Switching from the reverse phase drive state to the forward phase drive state is controlled in the same way.

The high potential side switching units 11A and 11B are p-channel MOS transistors in this embodiment of the invention, but the same effect can be achieved using n-channel MOS transistors instead. The switch control unit 4 and predriver units 5A and 5B are preferably logic circuits as shown in FIG. 4, but other devices that operate as described above can be used instead.

The regeneration gate voltage source is split in this embodiment between regenerative gate voltage sources 151A and 151B, but a single voltage source can be used because both voltage sources 151A and 151B are not used at the same time. Using a single regeneration gate voltage source does not affect the operation and advantage of this embodiment of the invention.

### Third Embodiment

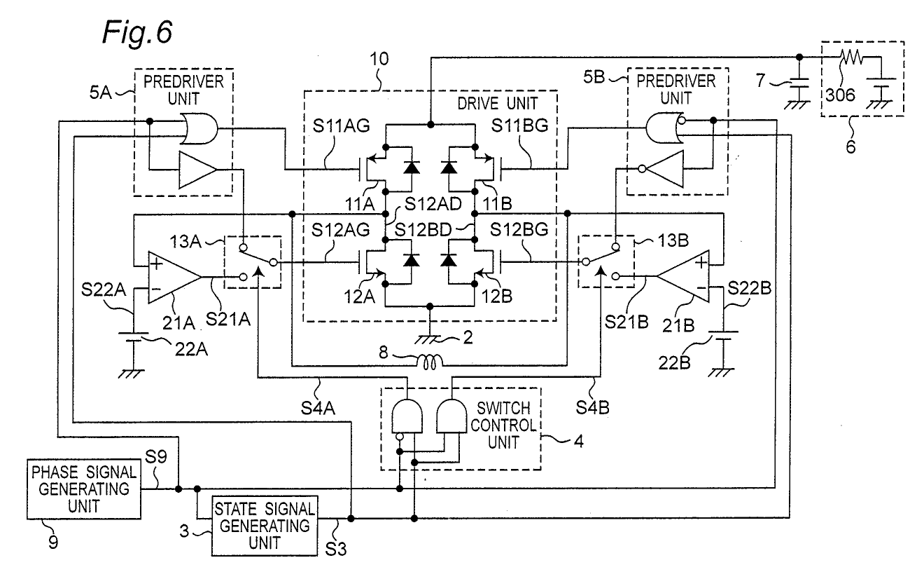

FIG. 6 is a schematic block diagram of an inductive load drive device according to a third embodiment of the invention.

This third embodiment replaces the regenerative gate voltage sources 151A, 151B used in the second embodiment with differential operators 21A and 21B and first reference voltage sources 22A and 22B. The differential operators 21A and 21B are differential amplifiers, for example. The first reference voltage sources 22A and 22B output a predetermined first reference voltage S22A and S22B, respectively.

This embodiment is described below with particular reference to the differences between this embodiment and the second embodiment.

In the normal phase drive state, the phase signal S9 and state signal S3 are LOW, the high potential side switching unit 11A is ON, and the high potential side switching unit 11B is OFF. The switch control signals S4A and S4B are LOW, the switches 13A and 13B are set to the predriver units 5A and 5B, respectively, the low potential side switching unit 12A is off and the low potential side switching unit 12B is on. As a result, the drive current flows through the drive current path from the power supply 6 to the high potential side switching unit 11A, inductive load 8, low potential side switching unit 12B, and to ground 2.

To switch the drive mode to the reverse phase from the normal phase, phase signal S9 goes from LOW to HIGH and the high potential side switching unit 11A goes off. The state signal S3 goes high for the predetermined regeneration period starting from when the phase signal S9 changes. The high potential side switching unit 11B therefore goes off. The characteristics of the inductive load 8 cause regenerative current to continue flowing to the inductive load 8 until the energy stored during the drive period is completely discharged.

Switching control signal S4A goes LOW, switching control signal S4B goes HIGH, switch 13A is set to the predriver unit 5A side, and switch 13B switches to the differential amplifier 21B side.

The second embodiment of the invention shortens the attenuation time by the regenerative gate voltage source 151B increasing the ON resistance of the low potential side switching unit 12B. Setting the regenerative gate voltage source 151 is shown in equations (3) and (4) above. This method enables applying the high voltage Vs+Vf (Vmax if Vmax<Vs+Vf) to both ends of the inductive load 8, but the drain voltage S12BD of the low potential side switching unit 12B thereafter decreases with attenuation of the regenerative current as shown in FIG. 5. The attenuation time of the regenerative current at this time can be determined by integrating dt in equation (5), which is a variation of equation (1), across the attenuation range of the regenerative current I(t). Note that Vd(t) is equivalent to the drain voltage S12BD of the low potential side switching unit 12B in the half ON high resistance ON state.
dt=−L/Vd(t)×dl(t) (5)

In this third embodiment of the invention the first reference voltage S22B is Vs+Vf (Vmax if Vmax<Vs+Vf), and differential amplifier 21B outputs difference signal S21B from drain voltage S12BD and first reference voltage S22B. This difference signal S21B controls the gate voltage S12BG of the low potential side switching unit 12B in the half ON high resistance ON state. As a result, the drain voltage S12BD can be held as close as possible to the first reference voltage S22B. In this case, the gate voltage S12BG of the low potential side switching unit 12B decreases and the ON resistance Ron of the low potential side switching unit 12B increases as the regenerative current I(t) attenuates. As a result, the product (I(t)×(Ron)) of the regenerative current I(t) and the ON resistance Ron is substantially constant.

Note that drain voltages S12AD and S12BD are also referred to as the voltage of the first main node.

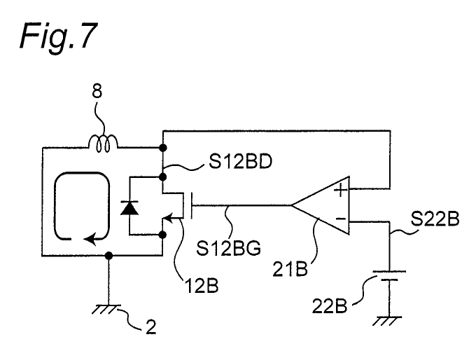

FIG. 7 is a partial circuit diagram describing circuit operation in the regeneration state. Note that the low potential side switching unit 12A is omitted in the figure because it is in the full ON low resistance ON state. The gate voltage S12BG of the low potential side switching unit 12B is controlled by the differential amplifier 21B so that the drain voltage S12BD of the low potential side switching unit 12B is always equal to the first reference voltage S22B. As a result, a voltage substantially equal to the first reference voltage S22B is applied to both ends of the inductive load 8.

The regenerative current therefore flows through the regenerative current path from ground 2 to the low potential side switching unit 12A in the full ON low resistance ON state, inductive load 8, the low potential side switching unit 12B in the half ON high resistance ON state, and to ground 2. Because no part of the regenerative current path flows to the power supply 6, the supply-to-ground capacitance 7 can be low. In addition, because the ON resistance of the low potential side switching unit 12B is high, the voltage at both ends of the inductive load 8 can be set high and the time required for regenerative current attenuation can be shortened.

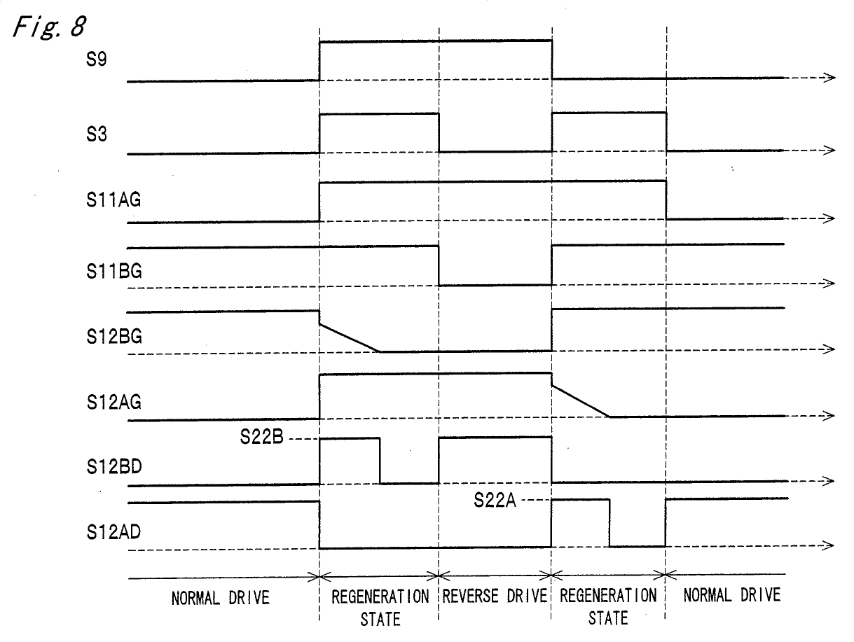

FIG. 8 is a waveform diagram of the voltage at various points. As shown in FIG. 8 the drain voltage S12BD of the low potential side switching unit 12B is always held equal to the first reference voltage S22B. The attenuation time of the regenerative current can be shortened even more than in the second embodiment because Vd(t) in equation (5) is constant at the peak level. The inductive load drive device enters the reverse phase drive state after the regeneration period set by the state signal generating unit 3. The high potential side switching unit 11B and low potential side switching unit 12A are on, and the drive current flows through the drive current path from the power supply 6 to the high potential side switching unit 11B, inductive load 8, low potential side switching unit 12A, and to ground 2.

The inductive load drive device according to this embodiment of the invention turns the high potential side switching unit group off when in the regeneration state, and regenerative current therefore does not flow to the power supply 6. As a result, the power supply voltage will not rise due current inflow even if an internal resistance 306 is present in the power supply. An extra safety margin is therefore not required when setting the withstand voltage of the inductive load drive device and the size of the supply-to-ground capacitance 7 can therefore be reduced, thus affording a low unit cost. The regeneration period can also be shortened because the regenerative current attenuation time can be shortened, and the time required to switch the phase of the inductive load between forward and reverse can be shortened.

Furthermore, because transistor on resistance can be feedback controlled to maximize the drain voltage while not exceeding the withstand voltage of the inductive load drive device, the resistance of the regenerative current path can be maximized more appropriately and the regenerative current attenuation time can be shortened even more because this path resistance shortens the power consumption time.

Phase switching from the forward phase drive state (with current flowing through the drive current path from the power supply 6 to the high potential side switching unit 11A, inductive load 8, low potential side switching unit 12B, and to ground 2) to the reverse phase drive state (with current flowing through the drive current path from the power supply 6 to the high potential side switching unit 11B, inductive load 8, low potential side switching unit 12A, and to ground 2) is described above. Switching from the reverse phase drive state to the forward phase drive state is controlled in the same way.

The high potential side switching units 11A and 11B are p-channel MOS transistors in this embodiment of the invention, but the same effect can be achieved using n-channel MOS transistors instead. The switch control unit 4 and predriver units 5A and 5B are preferably logic circuits as shown in FIG. 6, but other devices that operate as described above can be used instead.

Two differential operators 21A and 21B and first reference voltage sources 22A and 22B are used in this embodiment, but a single device can be used for each because neither the differential operators nor the first reference voltage sources are used at the same time. Using a single differential operator and a single first reference voltage source does not affect the operation and advantage of this embodiment of the invention.

### Fourth Embodiment

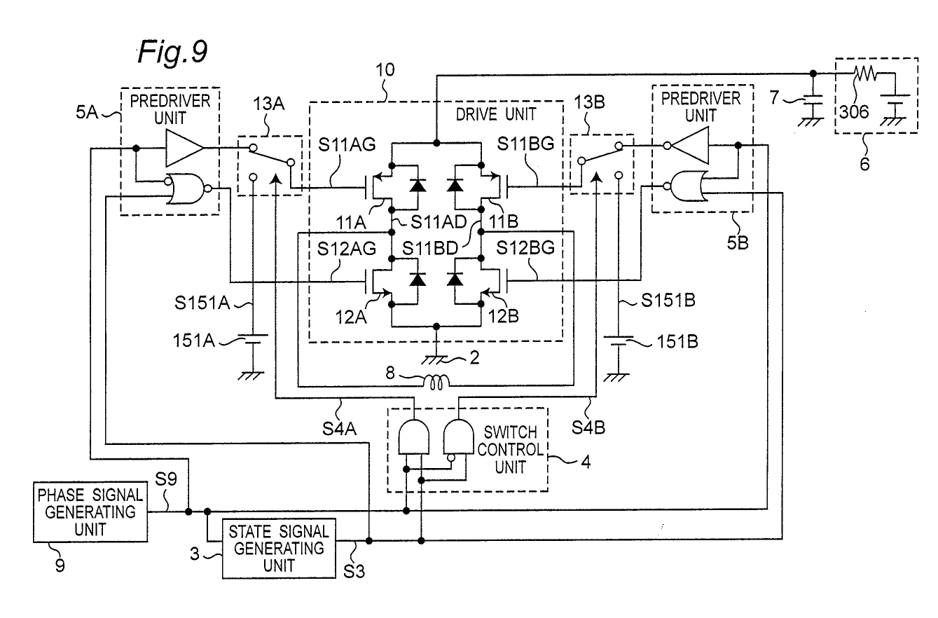

FIG. 9 is a schematic block diagram of an inductive load drive device according to a fourth embodiment of the invention.

In the second embodiment of the invention the regenerative current path passes through the low potential side switching unit group. This fourth embodiment of the invention differs by using the high potential side switching unit group instead of the low potential side switching unit group, and is described below primarily with reference to the differences between this embodiment and the second embodiment.

Shown in FIG. 9 are the inductive load 8, a drive unit 10 for supplying drive power to the inductive load 8, predriver units 5A and 5B, a power supply 6, a ground 2, a capacitance between the power supply and ground 7, an internal resistance 306 in the power supply, and a phase signal generating unit 9 for generating a phase signal S9 representing the forward or reverse phase state. A state signal generating unit 3 outputs a state signal S3 indicating whether the current operating state is the drive state or regeneration state. The state signal S3 goes HIGH for a predetermined regeneration period starting when the phase signal S9 changes phase.

The drive unit 10 includes high potential side switching units 11A and 11B, and low potential side switching units 12A and 12B. Each switching unit 11A, 11B, 12A, 12B has a body diode parallel connected in reverse conductivity. The high potential side switching units 11A and 11B have a regeneration switching function similarly to the low potential side switching units 12A and 12B in the second embodiment.

Switches 13A and 13B switch the gate voltage S11AG, S11BG of the high potential side switching units 11A and 11B. The switch control unit 4 generates the switch control signals S4A and S4B that control the switches 13A and 13B, respectively. When the switch control signal S4A, S4B is LOW, the corresponding switch 13A and 13B selects the output from the predriver units 5A and 5B, and selects the regenerative gate voltage source 151A, 151B when the switch control signal S4A and S4B is HIGH.

The operation of this inductive load drive device during phase switching is described next.

In the normal phase (forward) drive state the phase signal S9 and state signal S3 are LOW, low potential side switching unit 12A is OFF and low potential side switching unit 12B is ON. The switch control signals S4A and S4B are LOW, switches 13A and 13B are set to the predriver unit 5A and 5B side, respectively, high potential side switching unit 11A is ON and high potential side switching unit 11B is OFF. The drive current therefore flows from the power supply 6 to the high potential side switching unit 11A, inductive load 8, low potential side switching unit 12B, and to ground 2 through the drive current path.

When the phase is changed from this normal (forward) phase drive state, the phase signal S9 goes from LOW to HIGH and low potential side switching unit 12B goes off. The state signal S3 goes HIGH for a predetermined regeneration period starting when the phase signal S9 changes phase. As a result, the low potential side switching unit 12A also goes OFF. The characteristics of the inductive load 8 cause regenerative current to continue flowing to the inductive load 8 until the energy stored during the drive period is completely discharged. Switching control signal S4A goes HIGH, switching control signal S4B goes LOW, switch 13A is set to the regenerative gate voltage source 151A side, and switch 13B is set to the predriver unit 5B side. The high potential side switching unit 11B goes to the full ON low resistance ON state, but because the gate voltage S11AG of the high potential side switching unit 11A goes to regenerative gate voltage S151A, high potential side switching unit 11A goes to the half ON high resistance ON state.

As a result, the regenerative current flows through the regenerative current path from the half ON high resistance ON state high potential side switching unit 11A to the inductive load 8 and the full ON low resistance ON state high potential side switching unit 11B. Because no part of the regenerative current path flows to the power supply 6, the supply-to-ground capacitance 7 can be low. In addition, because the ON resistance of the high potential side switching unit 11A is high, the voltage at both ends of the inductive load 8 can be set high and the time required for regenerative current attenuation can be shortened.

The regeneration period can be set from equation (2) as described in the first embodiment. The regenerative gate voltage S151A is determined from equation (3) in the first and second embodiments, but is determined from equation (6) in this embodiment because the regenerative current path goes through the high potential side switching unit group.
(Imax)×(Ron)<Vs (6)
where Vs is the voltage of the power supply 6, Imax is the maximum current flow to the inductive load 8 in the drive period, and Ron is the ON resistance of the high potential side switching units 11A and 11B when in the half ON high resistance ON state.

The inductive load drive device then enters the reverse phase drive state after the regeneration period set by the state signal generating unit 3. The high potential side switching unit 11B and low potential side switching unit 12A are thus on, and the drive current flows through the drive current path from the power supply 6 to the high potential side switching unit 11B, inductive load 8, low potential side switching unit 12A, and to ground 2.

Phase switching from the forward phase drive state (with current flowing through the drive current path from the power supply 6 to the high potential side switching unit 11A, inductive load 8, low potential side switching unit 12B, and to ground 2) to the reverse phase drive state (with current flowing through the drive current path from the power supply 6 to the high potential side switching unit 11B, inductive load 8, low potential side switching unit 12A, and to ground 2) is described above. Switching from the reverse phase drive state to the forward phase drive state is controlled in the same way.

The high potential side switching units 11A and 11B are p-channel MOS transistors in this embodiment of the invention, but the same effect can be achieved using n-channel MOS transistors instead. The switch control unit 4 and predriver units 5A and 5B are preferably logic circuits as shown in FIG. 9, but other devices that operate as described above can be used instead.

The regeneration gate voltage source is split in this embodiment between regenerative gate voltage sources 151A and 151B, but a single voltage source can be used because both voltage sources 151A and 151B are not used at the same time. Using a single regeneration gate voltage source does not affect the operation and advantage of this embodiment of the invention.

### Fifth Embodiment

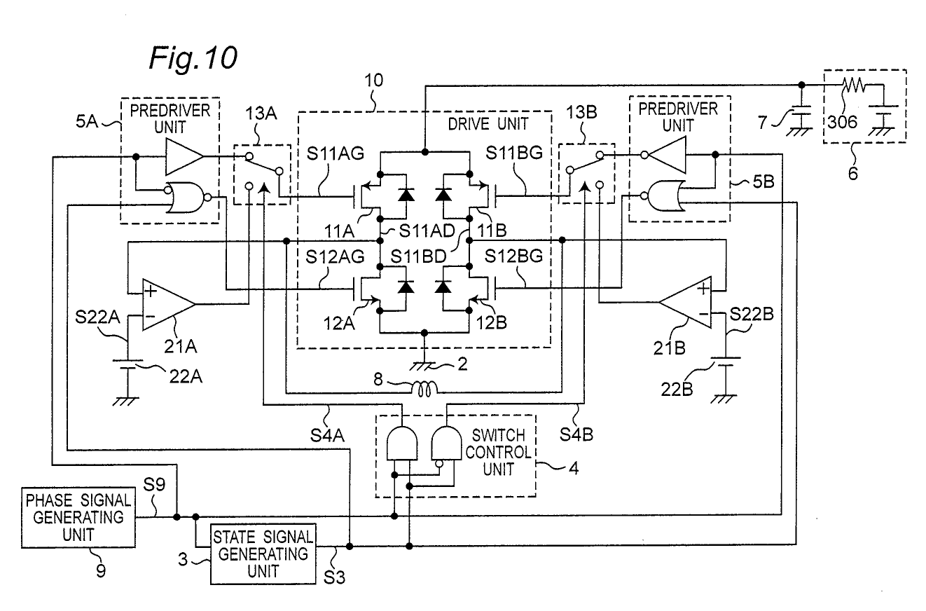

FIG. 10 is a schematic block diagram of an inductive load drive device according to a fifth embodiment of the invention.

In the third embodiment of the invention the regenerative current path passes through the low potential side switching unit group. This fifth embodiment of the invention differs from the third embodiment by using the high potential side switching unit group instead of the low potential side switching unit group, and is described below primarily with reference to the differences between this embodiment and the third embodiment.

In the third embodiment of the invention the first reference voltage S22B is Vs+Vf (Vmax if Vmax<Vs+Vf), and the drain voltage S12BD is held as high as possible by controlling the gate voltage S12BG of the low potential side switching unit 12B in the half ON high resistance ON state. In this fifth embodiment of the invention the first reference voltage S22A is the ground voltage, and the drain voltage S11AD is held substantially to the ground potential by controlling the gate voltage S11AG of the high potential side switching unit 11A in the half ON high resistance ON state. In this case the on resistance of the high potential side switching unit 11A increases as the regenerative current attenuates, and the product (I(t))×(Ron) of the regenerative current I(t) and ON resistance Ron is substantially constant. As a result, the attenuation time can be further decreased as in the third embodiment. The effect of this fifth embodiment is the same as described in the third embodiment, and further description thereof is thus omitted.

Phase switching from the forward phase drive state (with current flowing through the drive current path from the power supply 6 to the high potential side switching unit 11A, inductive load 8, low potential side switching unit 12B, and to ground 2) to the reverse phase drive state (with current flowing through the drive current path from the power supply 6 to the high potential side switching unit 11B, inductive load 8, low potential side switching unit 12A, and to ground 2) is described above. Switching from the reverse phase drive state to the forward phase drive state is controlled in the same way.

The high potential side switching units 11A and 11B are p-channel MOS transistors in this embodiment of the invention, but the same effect can be achieved using n-channel MOS transistors instead. The switch control unit 4 and predriver units 5A and 5B are preferably logic circuits as shown in FIG. 10, but other devices that operate as described above can be used instead.

Two differential operators 21A and 21B and first reference voltage sources 22A and 22B are used in this embodiment, but a single device can be used for each because neither the differential operators nor the first reference voltage sources are used at the same time. Using a single differential operator and a single first reference voltage source does not affect the operation and advantage of this embodiment of the invention.

### Sixth Embodiment

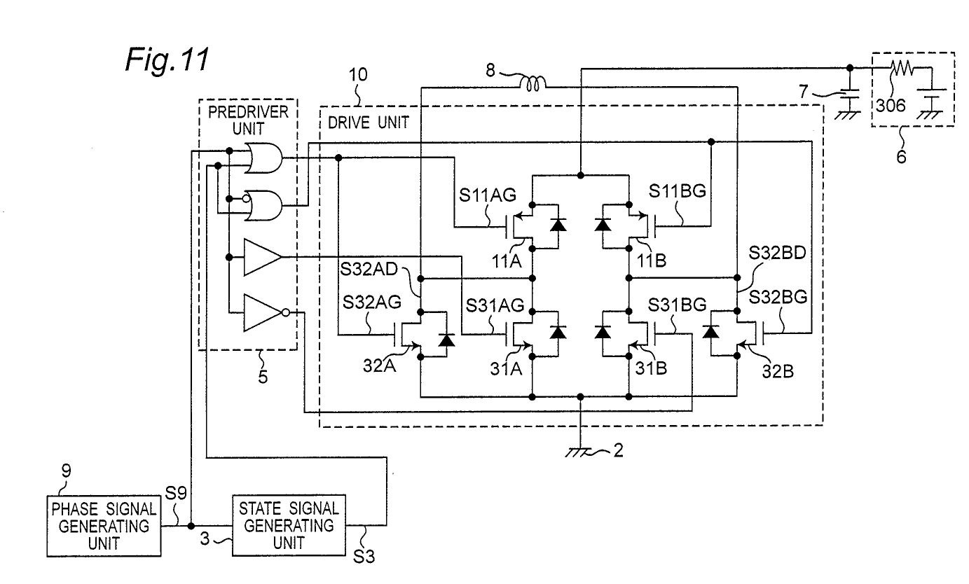

FIG. 11 is a schematic block diagram of an inductive load drive device according to a sixth embodiment of the invention.

Shown in FIG. 11 are the inductive load 8, a drive unit 10 for supplying drive power to the inductive load 8, predriver unit 5, a power supply 6, a ground 2, a capacitance between the power supply and ground 7, an internal resistance 306 in the power supply, and a phase signal generating unit 9 for generating a phase signal S9 representing the forward or reverse phase state. A state signal generating unit 3 outputs a state signal S3 indicating whether the current operating state is the drive state or regeneration state. The state signal S3 goes HIGH for a predetermined regeneration period starting when the phase signal S9 changes phase.

The drive unit 10 includes high potential side switching units 11A and 11B, low potential side first switching units 31A and 31B, and low potential side second switching units 32A and 32B. Each switching unit 11A, 11B, 12A, 12B has a body diode parallel connected in reverse conductivity. The high potential side switching units 11A and 11B together render a high potential side switching unit group, and the low potential side first switching units 31A and 31B and low potential side second switching units 32A and 32B together render a low potential side switching unit group.

The high potential side switching units 11A and 11B and low potential side first switching units 31A, 31B, 32A, and 32B each have a body diode parallel connected in reverse conductivity. Switching units 31A, 31B, 32A, and 32B each have a regeneration switching function similarly to the first embodiment.

This sixth embodiment of the invention renders the low potential side switching units 12A and 12B in the second embodiment by respectively connecting low potential side first switching units 31A and 31B and low potential side second switching units 32A and 32B in parallel. The differences between this and the second embodiment are described below.

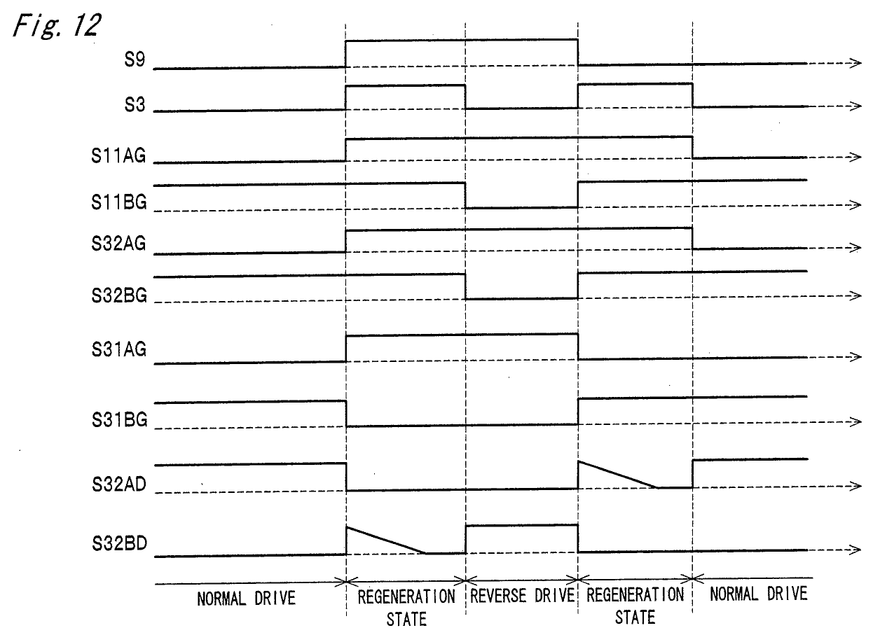

The phase switching operation of this inductive load drive device is described next with reference to FIG. 11 and the timing chart in FIG. 12.

In the normal (forward) phase drive state high potential side switching unit 11A is on and high potential side switching unit 11B is off, low potential side first switching unit 31B and low potential side second switching unit 32B are on, and low potential side first switching unit 31A and low potential side first switching unit 31B are off. The drive current therefore flows through a drive current path from the power supply 6 to high potential side switching unit 11A, inductive load 8, low potential side first switching unit 31B, low potential side second switching unit 32B, and to ground 2. Because both low potential side first switching unit 31B and low potential side second switching unit 32B are on at this time, the inductive load drive device operates in the low resistance ON state.

When the phase is switched from this forward phase drive state, the phase signal S9 goes from LOW to HIGH and high potential side switching unit 11A turns off. The state signal S3 goes HIGH for a predetermined regeneration period starting when the phase signal S9 changes phase. As a result, the high potential side switching unit 11B also goes OFF. The characteristics of the inductive load 8 cause regenerative current to continue flowing to the inductive load 8 until the energy stored during the drive period is completely discharged. The low potential side first switching unit 31A and low potential side second switching unit 32A go on, low potential side first switching unit 31B goes off, and low potential side second switching unit 32B goes on. The low potential side first switching unit 31A is in the low resistance ON state at this time, but the low potential side second switching units 32A and 32B are in the high resistance ON state.

The regenerative current therefore flows through the regenerative current path from ground 2 to low potential side first switching unit 31A in the low resistance ON state, low potential side second switching unit 32A in the high resistance ON state, inductive load 8, low potential side second switching unit 32B in the high resistance ON state, and to ground 2. Because no part of the regenerative current path flows to the power supply 6, the supply-to-ground capacitance 7 can be low. In addition, because the ON resistance of the low potential side second switching unit 32B is high, the voltage at both ends of the inductive load 8 can be set high and the time required for regenerative current attenuation can be shortened.

As in the first embodiment, the on resistance of the low potential side second switching units 32A and 32B can be set using equation (3). The regeneration period can be set using equation (2). The inductive load drive device enters the reverse phase drive state after the regeneration period set by the state signal generating unit 3. The high potential side switching unit 11B, low potential side first switching unit 31A, and low potential side second switching unit 32A are thus on, and the drive current flows through the drive current path from the power supply 6 to high potential side switching unit 11B, inductive load 8, low potential side first switching unit 31A and low potential side second switching unit 32A, and to ground 2.

The inductive load drive device according to this sixth embodiment of the invention turns the high potential side switching unit group off in the regeneration period, and the regenerative current therefore does not flow to the power supply 6. As a result, the power supply voltage will not rise due current inflow even if an internal resistance 306 is present in the power supply. An extra safety margin is therefore not required when setting the withstand voltage of the inductive load drive device and the size of the supply-to-ground capacitance 7 can therefore be reduced, thus affording a low unit cost. The regeneration period can also be shortened because the regenerative current attenuation time can be shortened, and the time required to switch the phase of the inductive load between forward and reverse can be shortened.

In addition, the resistance of the regenerative current path can be increased by using a high ON resistance second switching device in the regeneration period, the power consumption time is thus shortened by the path resistance, and the regenerative current attenuation time can be further shortened.

Phase switching from the forward phase drive state (with current flowing through the drive current path from the power supply 6 to the high potential side switching unit 11A, inductive load 8, low potential side first switching unit 31B, low potential side second switching unit 32B, and to ground 2) to the reverse phase drive state (with current flowing through the drive current path from the power supply 6 to the high potential side switching unit 11B, inductive load 8, low potential side first switching unit 31A and low potential side second switching unit 32A, and to ground 2) is described above. Switching from the reverse phase drive state to the forward phase drive state is controlled in the same way.

The high potential side switching units 11A and 11B are p-channel MOS transistors in this embodiment of the invention, but the same effect can be achieved using n-channel MOS transistors instead. The predriver unit 5 is preferably a logic circuit as shown in FIG. 11, but other devices that operate as described above can be used instead.

### Seventh Embodiment

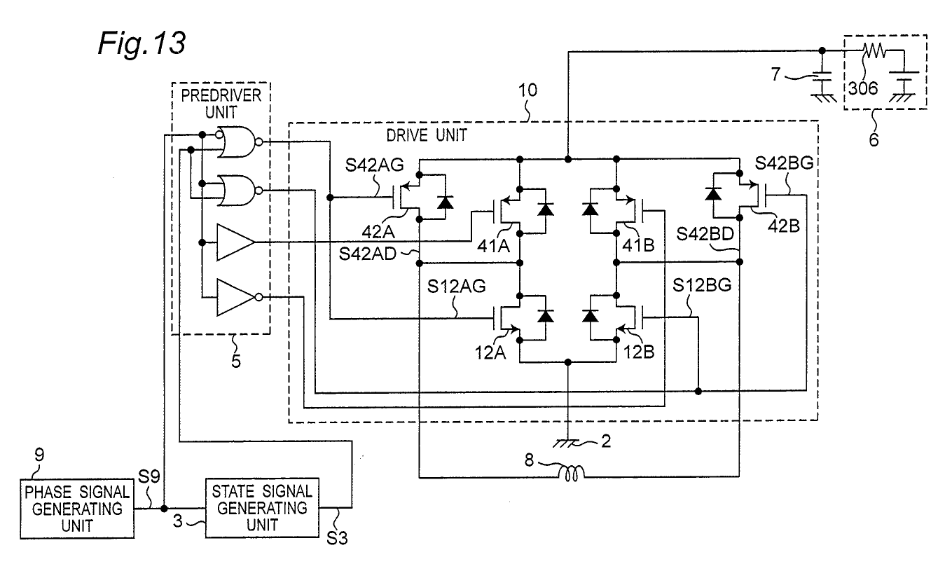

FIG. 13 is a schematic block diagram of an inductive load drive device according to a seventh embodiment of the invention.

This seventh embodiment of the invention replaces the low potential side switching unit group in the regenerative current path in the sixth embodiment with a high potential side switching unit group, and the arrangement of the drive unit 10 and predriver unit 5 changes accordingly. Other aspects of this embodiment are the same as in the sixth embodiment, the operation and effect of this embodiment are also the same as in the sixth embodiment, and further description thereof is thus omitted below.

### Eighth Embodiment

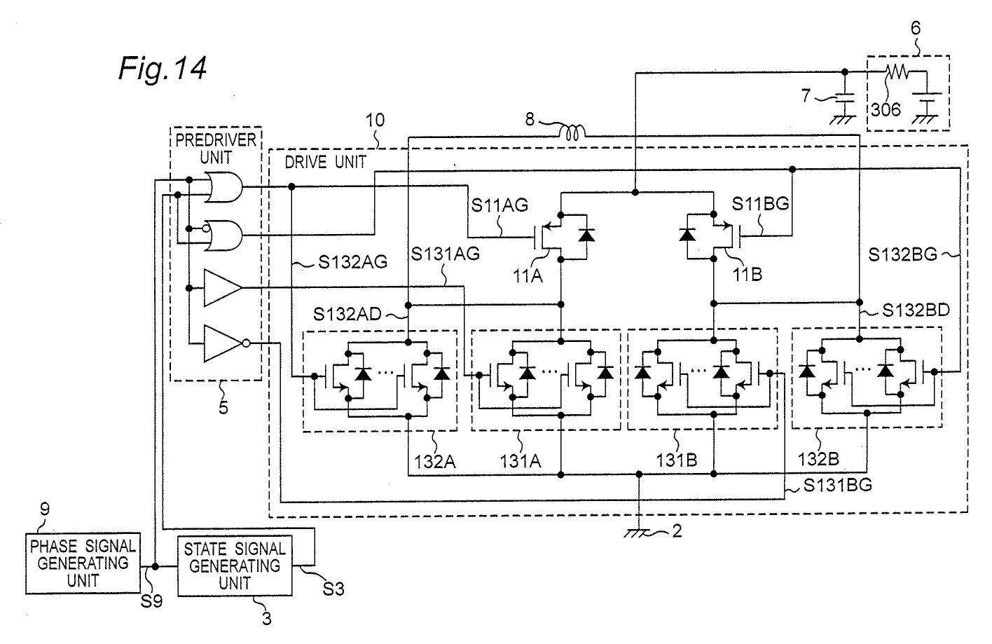

FIG. 14 is a schematic block diagram of an inductive load drive device according to an eighth embodiment of the invention.

Shown in FIG. 14 are the inductive load 8, a drive unit 10 for supplying drive power to the inductive load 8, predriver unit 5, a power supply 6, a ground 2, a capacitance between the power supply and ground 7, an internal resistance 306 in the power supply, and a phase signal generating unit 9 for generating a phase signal S9 representing the forward or reverse phase state. A state signal generating unit 3 outputs a state signal S3 indicating whether the current operating state is the drive state or regeneration state. The state signal S3 goes HIGH for a predetermined regeneration period starting when the phase signal S9 changes phase.

The drive unit 10 includes high potential side switching units 11A and 11B, and low potential side third switching units 131A, 131B, 132A, 132B. The high potential side switching units 11A and 11B together render a high potential side switching unit group, and the low potential side third switching units 131A, 131B, 132A, 132B are referred to the low potential side switching unit group. Each switching unit 11A, 11B, and low potential side third switching units 131A, 131B, 132A, 132B have a body diode parallel connected in reverse conductivity.

As in the first embodiment, the low potential side third switching units 131A, 131B, 132A, 132B have a regenerative switching function.

This embodiment of the invention renders the low potential side switching units 12A and 12B in the sixth embodiment by respectively parallel connecting low potential side third switching units 131A and 131B having a low ON resistance and low potential side third switching units 132A and 132B with a high ON resistance. The low potential side third switching unit group 131A, 131B, 132A, 132B is rendered by parallel connecting third switching devices, and the number of parallel connected third switching devices in low potential side third switching unit group 132A and 132B is less than in the low potential side third switching unit group 131A and 131B. The number of parallel connected third switching devices is determines so that when in the full ON state low potential side third switching units 131A and 131B are in the low resistance ON state, and low potential side third switching units 132A and 132B are in the high resistance ON state.

The differences between this eighth embodiment and the sixth embodiment are described below.

The phase switching operation of this inductive load drive device is described next.

In the normal (forward) phase drive state high potential side switching unit 11A is on and high potential side switching unit 11B is off, low potential side third switching units 131B and 132B are on, and low potential side third switching units 131A and 131B are off. The drive current therefore flows through a drive current path from the power supply 6 to high potential side switching unit 11A, inductive load 8, low potential side third switching units 131B and 132B, and to ground 2. Because both low potential side third switching units 131B and 132B are on at this time, the inductive load drive device operates in the low resistance ON state.

When the phase is switched from this forward phase drive state, the phase signal S9 goes from LOW to HIGH and high potential side switching unit 11A turns off. The state signal S3 goes HIGH for a predetermined regeneration period starting when the phase signal S9 changes phase. As a result, the high potential side switching unit 11B also goes OFF. The characteristics of the inductive load 8 cause regenerative current to continue flowing to the inductive load 8 until the energy stored during the drive period is completely discharged. The low potential side third switching units 131A and 132A go on, low potential side third switching unit 131B goes off, and low potential side third switching unit 132B goes on. The low potential side third switching unit 131A is in the low resistance ON state at this time, but the low potential side third switching units 132A and 132B are in the high resistance ON state.

The regenerative current therefore flows through the regenerative current path from ground 2 to low potential side third switching unit 131A in the low resistance ON state and low potential side third switching unit 132A in the high resistance ON state, inductive load 8, low potential side third switching unit 132B in the high resistance ON state, and to ground 2. Because no part of the regenerative current path flows to the power supply 6, the supply-to-ground capacitance 7 can be low. In addition, because the ON resistance of the low potential side third switching unit 132B is high, the voltage at both ends of the inductive load 8 can be set high and the time required for regenerative current attenuation can be shortened.

As in the first embodiment, the on resistance of the low potential side third switching units 132A and 132B can be set using equation (3). The regeneration period can be set using equation (2). The inductive load drive device enters the reverse phase drive state after the regeneration period set by the state signal generating unit 3. The high potential side switching unit 11B and low potential side third switching units 131A and 132A are thus on, and the drive current flows through the drive current path from the power supply 6 to high potential side switching unit 11B, inductive load 8, low potential side third switching units 131A and 132A, and to ground 2.

The inductive load drive device according to this embodiment of the invention turns the high potential side switching unit group off in the regeneration period, and the regenerative current therefore does not flow to the power supply 6. As a result, the power supply voltage will not rise due current inflow even if an internal resistance 306 is present in the power supply. An extra safety margin is therefore not required when setting the withstand voltage of the inductive load drive device and the size of the supply-to-ground capacitance 7 can therefore be reduced, thus affording a low unit cost. The regeneration period can also be shortened because the regenerative current attenuation time can be shortened, and the time required to switch the phase of the inductive load between forward and reverse can be shortened.

In addition, by rendering the number of switching units that are ON in the regenerative current path, the path resistance can be increased, this path resistance can shorten the power consumption time, and the regenerative current attenuation time can be further shortened.

Phase switching from the forward phase drive state (with current flowing through the drive current path from the power supply 6 to the high potential side switching unit 11A, inductive load 8, low potential side third switching units 131B and 132B, and to ground 2) to the reverse phase drive state (with current flowing through the drive current path from the power supply 6 to the high potential side switching unit 11B, inductive load 8, low potential side third switching units 131A and 132A, and to ground 2) is described above. Switching from the reverse phase drive state to the forward phase drive state is controlled in the same way.

The high potential side switching units 11A and 11B are p-channel MOS transistors in this embodiment of the invention, but the same effect can be achieved using n-channel MOS transistors instead. The predriver unit 5 is preferably a logic circuit as shown in FIG. 14, but other devices that operate as described above can be used instead.

### Ninth Embodiment

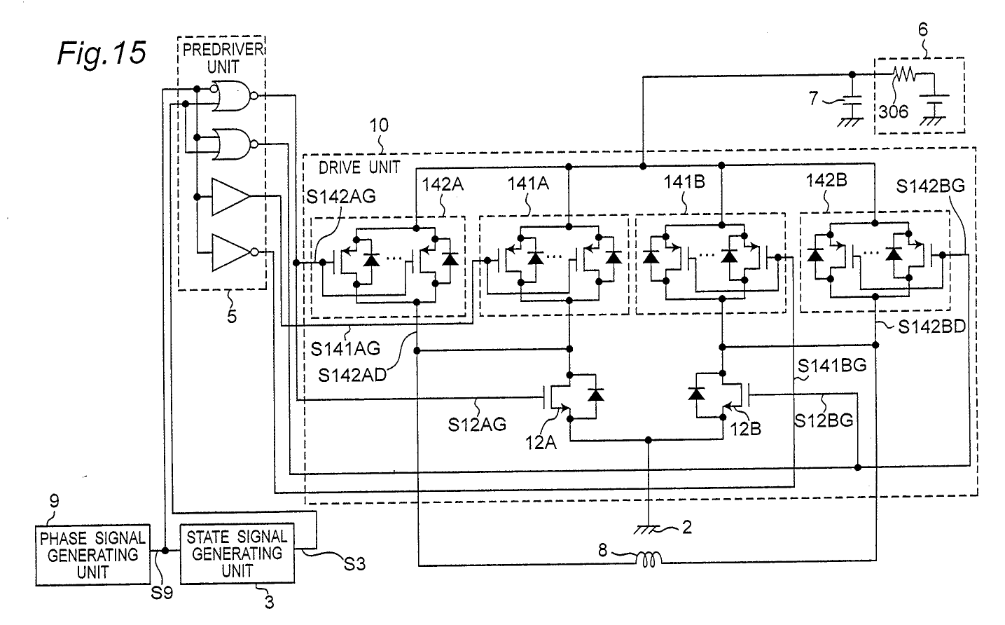

FIG. 15 is a schematic block diagram of an inductive load drive device according to a ninth embodiment of the invention.

This ninth embodiment of the invention replaces the low potential side switching unit group in the regenerative current path in the eighth embodiment with a high potential side switching unit group. Other aspects of this embodiment are the same as in the eighth embodiment, the operation and effect of this embodiment are also the same as in the eighth embodiment, and further description thereof is thus omitted below.

### Tenth Embodiment

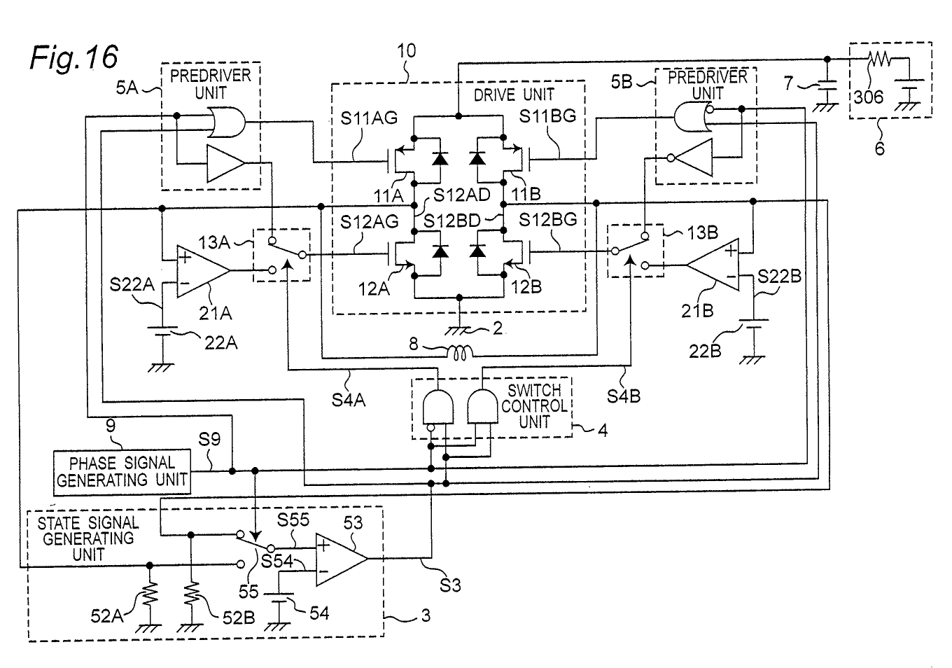

FIG. 16 is a schematic block diagram of an inductive load drive device according to a tenth embodiment of the invention.

In the second through ninth embodiments described above the state signal generating unit 3 sets the regeneration period by generating a state signal based on a phase signal. This tenth embodiment of the invention, however, sets the regeneration period by detecting regenerative current attenuation based on a comparison of the voltage at both ends of the inductive load 8 and a predetermined second reference voltage. This tenth embodiment of the invention shown in FIG. 16 differs from the third embodiment shown in FIG. 6 in that the terminal voltages of the inductive load 8 are input to the state signal generating unit 3, which generates the state signal S3 based on these terminal voltages. The differences between this tenth embodiment of the invention and the third embodiment are described below.

Referring to FIG. 16, the inductive load drive device according to this embodiment of the invention additionally has pull-down resistances 52A and 52B for fixing the drain voltages S12AD and S12Bd of the low potential side switching units 12A and 12B at the ground potential, a second reference voltage source 54 for outputting a predetermined second reference voltage S54, a switch 55 that operates selectively according to the phase signal S9, and a comparator 53 for comparing the output voltage S55 of the switch 55 with the second reference voltage S54 to output state signal S3. In this embodiment of the invention the state signal S3 is also called a comparison result signal.

In the normal (forward) phase drive state the phase signal S9 and state signal S3 are LOW, high potential side switching unit 11A is ON and high potential side switching unit 11B is OFF. The switch control signals S4A and S4B are LOW, the switches 13A and 13B are set to the predriver units 5A and 5B, respectively, the low potential side switching unit 12A is off and the low potential side switching unit 12B is on. As a result, the drive current flows through the drive current path from the power supply 6 to the high potential side switching unit 11A, inductive load 8, low potential side switching unit 12B, and to ground 2.

To switch the drive mode to the reverse phase from the normal phase, phase signal S9 goes from LOW to HIGH and the high potential side switching unit 11A goes off. The state signal S3 goes high for the predetermined regeneration period starting from when the phase signal S9 changes. The high potential side switching unit 11B therefore goes off. The characteristics of the inductive load 8 cause regenerative current to continue flowing to the inductive load 8 until the energy stored during the drive period is completely discharged.

Switching control signal S4A goes LOW, switching control signal S4B goes HIGH, switch 13A is set to the predriver unit 5A side, and switch 13B switches to the differential amplifier 21B side.

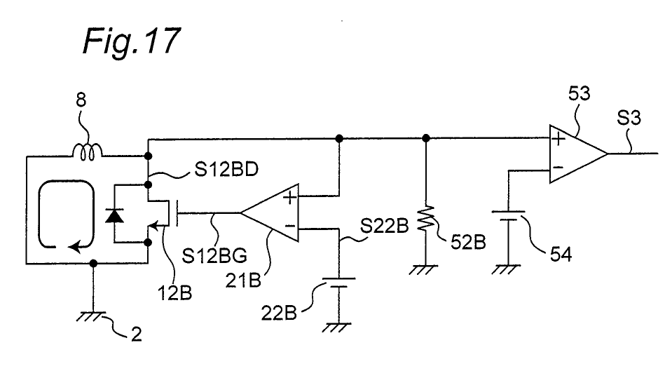

FIG. 17 is a partial circuit diagram describing circuit operation in the regeneration state. Note that the low potential side switching unit 12A is omitted in the figure because it is in the full ON low resistance ON state. The gate voltage S12BG of the low potential side switching unit 12B is controlled by the differential amplifier 21B so that the drain voltage S12BD of the low potential side switching unit 12B is always equal to the first reference voltage S22B. As a result, a voltage substantially equal to the first reference voltage S22B is applied to both ends of the inductive load 8.

The regenerative current therefore flows through the regenerative current path from ground 2 to the low potential side switching unit 12A in the full ON low resistance ON state, inductive load 8, the low potential side switching unit 12B in the half ON high resistance ON state, and to ground 2. Because no part of the regenerative current path flows to the power supply 6, the supply-to-ground capacitance 7 can be low. In addition, because the ON resistance of the low potential side switching unit 12B is high, the voltage at both ends of the inductive load 8 can be set high and the time required for regenerative current attenuation can be shortened.

As the regenerative current attenuates in the regeneration state the gate voltage S12BG of the low potential side switching unit 12B decreases to the first reference voltage S22B. When the regenerative current has completely dissipated, the gate voltage S12BG is less than or equal to the ON threshold voltage of the low potential side switching unit 12B, and the low potential side switching unit 12B turns off. The pull-down resistance 52B fixes the drain voltage S12BD at the ground potential at this time. More specifically, the drain voltage S12BD is held equal to the first reference voltage S22B during the regeneration period, and is fixed by the pull-down resistance 52B to the ground potential when the regenerative current has completely dissipated. This switching is detected by the second reference voltage source 54 and comparator 53 to output the state signal S3. FIG. 17 shows only the circuit block related to this detection operation.

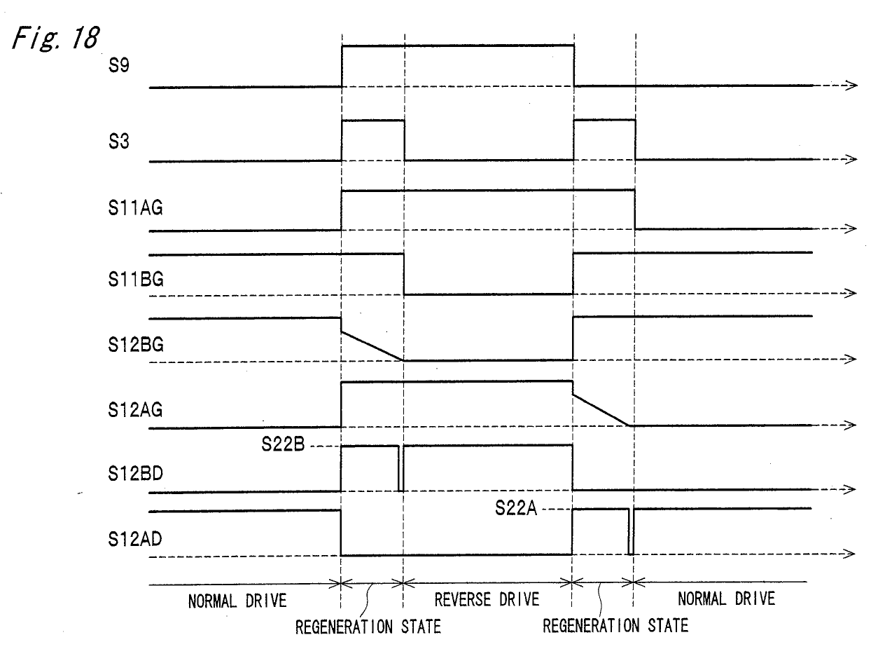

When this state signal S3 is applied, the drive unit 10 switches to the reverse phase drive state. The high potential side switching unit 11B and low potential side switching unit 12A are ON, and the drive current flows through the drive current path from the power supply 6 to high potential side switching unit 11B, inductive load 8, low potential side switching unit 12A, and to ground 2. FIG. 18 is a voltage diagram of the signals at selected points of this operation. Because the reverse phase drive state is enabled as soon as regenerative current attenuation is detected, the operating phase can be switched quickly without wasting time.

The inductive load drive device according to this embodiment of the invention turns the high potential side switching unit group off when in the regeneration state, and regenerative current therefore does not flow to the power supply 6. As a result, the power supply voltage will not rise due current inflow even if an internal resistance 306 is present in the power supply. An extra safety margin is therefore not required when setting the withstand voltage of the inductive load drive device and the size of the supply-to-ground capacitance 7 can therefore be reduced, thus affording a low unit cost. The regeneration period can also be shortened because the regenerative current attenuation time can be shortened, and the time required to switch the phase of the inductive load between forward and reverse can be shortened.

The regenerative current attenuation time can be further shortened because attenuation of the regenerative current is monitored and the reverse phase drive state is enabled as soon as dissipation of the regenerative current is detected.

The regenerative current does not flow to the power supply side with the inductive load drive device and drive method of the invention, and the power supply voltage is therefore not increased by inflowing current even when there is an internal resistance in the power supply. The withstand voltage of the inductive load drive device can therefore be designed without an extra safety margin, the size of the capacitance between the power supply and ground can therefore be reduced, and the cost can therefore be reduced. The attenuation time of the regenerative current can therefore be shortened, the regeneration period can be minimized, and the forward/reverse phase switching time of the inductive load can be shortened.

More specifically, controlling the on resistance of the transistor enables increasing the resistance of the regenerative current path and enables shortening the regenerative current attenuation time because the current consumption time of the path resistance is shortened.

Furthermore, because transistor on resistance can be feedback controlled to maximize the drain voltage while not exceeding the withstand voltage of the inductive load drive device, the resistance of the regenerative current path can be maximized more appropriately and the regenerative current attenuation time can be shortened even more because this path resistance shortens the power consumption time.

In addition, the resistance of the regenerative current path can be increased by selectively using a high ON resistance transistor in the regeneration state, and the regenerative current attenuation time can be shortened even more because this path resistance shortens the power consumption time.

Yet further, by selecting the number of transistors that are on in the regenerative current path, the path resistance can be increased and the regenerative current attenuation time can be further shortened because this path resistance shortens the power consumption time.

The regenerative current attenuation time can be yet further shortened by monitoring regenerative current attenuation and switching to the reverse phase drive state as soon as attenuation is completed.

Other objects and attainments together with a fuller understanding of the invention will become apparent and appreciated by referring to the following description and claims taken in conjunction with the accompanying drawings.

Phase switching from the forward phase drive state (with current flowing through the drive current path from the power supply 6 to the high potential side switching unit 11A, inductive load 8, low potential side switching unit 12B, and to ground 2) to the reverse phase drive state (with current flowing through the drive current path from the power supply 6 to the high potential side switching unit 11B, inductive load 8, low potential side switching unit 12A, and to ground 2) is described above. Switching from the reverse phase drive state to the forward phase drive state is controlled in the same way.

The high potential side switching units 11A and 11B are p-channel MOS transistors in this embodiment of the invention, but the same effect can be achieved using n-channel MOS transistors instead. The switch control unit 4 and predriver units 5A and 5B are preferably logic circuits as shown in FIG. 16, but other devices that operate as described above can be used instead.

Two differential operators 21A and 21B and first reference voltage sources 22A and 22B are used in this embodiment, but a single device can be used for each because neither the differential operators nor the first reference voltage sources are used at the same time. Using a single differential operator and a single first reference voltage source does not affect the operation and advantage of this embodiment of the invention.

The present invention is described with reference to the foregoing embodiments of the invention by way of example only, and is not limited to these embodiments.

The present invention can be used in an inductive load drive device and a drive method for an inductive load drive device.

What is claimed is:

1. An inductive load drive device operable to drive an inductive load by repeatedly switching between a drive state supplying drive power to the inductive load and a regeneration state receiving regenerative power from the inductive load, comprising:
a drive signal generator operable to generate a drive signal denoting a logic level of the drive state and the regeneration state; and
a driver that is controlled based on the drive signal to an OFF state, a high resistance ON state having a high ON resistance, or a low resistance ON state having a low ON resistance, to generate the drive power;
wherein the driver comprises
a high potential side switching unit group having at least one switching unit; and
a low potential side switching unit group having at least one switching unit;
where either the high potential side switching unit group or the low potential side switching unit group is controlled to the OFF state and at least one switching unit of the other switching unit group is controlled to the high resistance ON state in the regeneration state.

2. The inductive load drive device described in claim 1, wherein the switching units of the other switching unit group other than the switching unit in the high resistance ON state are controlled to the low resistance ON state.

3. The inductive load drive device described in claim 1, wherein the switching unit that is controlled to the high resistance ON state is controlled to the low resistance ON state during the drive state.

4. The inductive load drive device described in claim 3, wherein the level of the drive signal applied to the control node of the switching unit is lower in the regeneration state than in the drive state.

5. The inductive load drive device described in claim 1, wherein the driver supplies forward phase and reverse phase drive power to the inductive load during the drive state.

6. The inductive load drive device described in claim 1, further comprising:
a differential operator operable to output a difference signal between a voltage at a first main node of the switching unit controlled to the high resistance ON state and a predetermined first reference voltage;
wherein the switching unit is controlled based on the difference signal when in the high resistance ON state.

7. The inductive load drive device described in claim 1, wherein the switching unit controlled to the high resistance ON state comprises a first switching device having a low ON resistance parallel connected to a second switching device having a high ON resistance; and
the first switching device is controlled to the OFF state and the second switching device is controlled to the high resistance ON state when in the regeneration state.

8. The inductive load drive device described in claim 1, wherein the switching unit controlled to the high resistance ON state comprises three or more parallel connected switching devices; and
of the three or more switching devices, at least one is controlled to the high resistance ON state and the other switching devices are controlled to the OFF state when in the regeneration state.

9. The inductive load drive device described in claim 1, wherein the drive signal generator comprises
a comparator operable to compare a voltage at a first main node of the switching unit controlled to the high resistance ON state and a predetermined second reference voltage, and to output a comparison result signal; and
controls the drive signal based on the comparison result signal to switch the driver from the regeneration state to the drive state.

10. An inductive load drive method operable to drive an inductive load by repeatedly switching between a drive state supplying drive power to the inductive load and a regeneration state receiving regenerative power from the inductive load by a high potential side switching unit group having at least one switching unit, and a low potential side switching unit group having at least one switching unit, comprising:
generating a drive signal denoting a logic level of the drive state and the regeneration state;
generating the drive power controlled based on the drive signal to an OFF state, a high resistance ON state having a high ON resistance or a low resistance ON state having a low ON resistance; and
controlling either the high potential side switching unit group or the low potential side switching unit group to the OFF state and at least one switching unit of the other switching unit group to the high resistance ON state in the regeneration state.
